(19) United States
(12) Patent Application Publication
(10) Pub. No.: US 2008/0008632 A1
(43) Pub. Date: Jan. 10, 2008

(54) PRESSURIZED UV/O3 WATER PURIFICATION SYSTEM

(76) Inventor: Rolf Engelhard, Prescott, AZ (US)

Correspondence Address: C. ROBERT VON HELLENS;CAHILL, VON HELLENS & GLAZER P.L.C., 155 PARK ONE,, 2141 E. HIGHLAND AVENUE, PHOENIX, AZ, 85016, US

(21) Appl. No.: 11/456,171

(22) Filed: Jul. 7, 2006

(51) Int. Cl. B01J 19/12

(52) U.S. Cl. 422/186.3

(57) ABSTRACT

An oxygen containing gas is injected at a pressure in the range of about two (2) to about five (5) atmospheres or more into an ultraviolet transmissive sleeve surrounding an ultraviolet lamp to produce a high concentration of ozone. Simultaneously, the ultraviolet lamp irradiates water to be purified disposed in a container surrounding the sleeve. The ozone enriched gas is entrained into the water flowing into the container resulting in an oxidative reaction with any organic matter present and coming into contact with the ozone. Alternatively, the ozone may be entrained in water in a second container downstream of the container wherein the water has been irradiated with ultraviolet radiation. In a further variant, the ozone may be entrained in water in a container upstream of the container wherein the water has been irradiated with ultraviolet radiation. In a yet further variant, the ozone may be entrained in one or more containers upstream and prior to irradiation of the water with ultraviolet radiation in the downstream most container. The ozone may be extracted from the ozonated water prior to discharge if the oxidative effect of the ozone is not desired for the intended end use. To enhance ozone production a predetermined pressure is maintained within the sleeve. To prevent damage to sleeve in the event of a drop in pressure of the water surrounding the sleeve, a further differential pressure regulator may be used to relieve the pressure within the sleeve by discharging ozonated gas from within the sleeve. By use of specifically configured end caps for the sleeve, certain existing water purification systems may be converted to embody the present invention.

### CROSS-REFERENCE TO RELATED APPLICATIONS

The present application is related to an application entitled “Pressurized UV/O₃ Water Purification System”, Ser. No. 09/588,905 filed Jun. 7, 2000 (now abandoned), which application discloses information common with and claimed priority to a provisional application entitled “PRESSURIZED UV/O₃ WATER PURIFICATION SYSTEM”, filed Jun. 11, 1999 and assigned Ser. No. 60/138,935.

### BACKGROUND OF THE INVENTION

1. Field of the Invention

The present invention relates to water purification systems and, more particularly to generating ozone under pressure for entraimnent in water in combination with ultraviolet radiation to purify the water.

2. Description of Related Art

Water treatment systems using a source of ultraviolet radiation to irradiate water are common for industrial and potable water treatment systems. Moreover, water treatment systems which inject ozone into the water are well-known. Some water treatment systems irradiate the water with ultraviolet radiation and inject ozone into the water to combine the advantages achieved from ultraviolet radiation and ozonation. U.S. Pat. Nos. 5,266,215 and 5,709,799 illustrates a water treatment system embodying ultraviolet irradiation before and after filtration of the water to be treated. U.S. Pat. No. 5,540,848 describes apparatus for irradiating water to be treated with ultraviolet radiation and ozonating the water before and after passage through a filter. All three of these patents are incorporated herein by reference.

In order to produce a significant amount of ozone, a corona discharge system is the preferred prior art method to produce ozone. Ultraviolet radiation of oxygen or an oxygen containing gas can be used but the concentrations of ozone thus produced by prior art apparatus are normally well-below the level of ozone production available from a corona discharge system. Consequently, it has been very difficult to produce a significant amount of ozone by ultraviolet radiation of oxygen or of an oxygen containing gas for entrainment in water.

### SUMMARY OF THE INVENTION

An ultraviolet lamp is mounted within a pressurizable ultraviolet transmissive sleeve. Air or other oxygen containing gas is conveyed under two or more atmospheres of pressure into the sleeve. The sleeve is disposed within a container housing the water to be purified. Upon energizing the lamp, the water surrounding the sleeve will be irradiated with ultraviolet radiation through the ultraviolet transmissive sleeve. Simultaneously, ultraviolet irradiation of the oxygen containing gas under pressure will produce ozone (03) in significant quantities and on the order of one magnitude greater than that produced from an oxygen containing gas irradiated by ultraviolet radiation at atmospheric pressure. The ozone is conveyed under pressure and injected into one or more vessels containing the water to be purified for entrainment therein. Downstream, any ozone may be converted to oxygen to eliminate residual ozone or the residual ozone may be maintained to perform disinfecting functions in downstream equipments.

It is therefore a primary object of the present invention to inject a high concentration of ozone into the water of a water purification system.

Another object of the present invention is to provide an ultraviolet generator for producing high concentrations of ozone to be conveyed into the water of a water purification system.

Still another object of the present invention is to provide the combined germicidal and oxidative effects of UV radiation and high concentrations of ozone in a water purification system.

Yet another object of the present invention is to provide a pressure environment for an oxygen containing gas in an ozone generator to enhance the concentration of ozone produced for use in a water purification system.

A further object of the present invention is to provide a water purification system having one chamber for irradiating the water with a source of ultraviolet radiation and another chamber for producing high concentrations of ozone with the ultraviolet source and injecting the ozone into the water.

A still further object of the present invention is to provide a water purification system free of residual ozone for potable water or to retain residual ozone for its oxidative effect on the equipment downstream.

A yet further object of the present invention is to provide a method for producing a high concentration of ozone with a sourse of ultraviolet radiation and for using the ozone to purify water.

A yet further object of the present invention is to provide a method for purifying water by injecting high concentrations of ozone into the water and by irradiating the water with ultraviolet radiation.

These and other objects of the present invention will become apparent to those skilled in the art as the description there proceeds.

### BRIEF DESCRIPTION OF THE DRAWINGS

The present invention will be described with greater specificity and clarity with reference to the following drawings, in which:

FIG. 1 illustrates a water purification system for irradiating water with ultraviolet radiation and for producing a high concentration of ozone-rich gas to be entrained in the water;

FIG. 2 illustrates in detail the structure for sealing a sleeve surrounding an ultraviolet lamp;

FIG. 3 illustrates a variant of the water purification system shown in FIG. 1;

FIG. 4 illustrates a two-step water purification system wherein ozone is initially injected into the water and the water is subsequently irradiated with ultraviolet light;

FIG. 5 illustrates a two-step water purification system wherein the water is initially irradiated with ultraviolet radiation and subsequently injected with ozone;

FIG. 6 illustrates a commercial version of the present invention; and

FIG. 7 illustrates a further commercial version of the present invention.

### DESCRIPTION OF THE PREFERRED EMBODIMENT

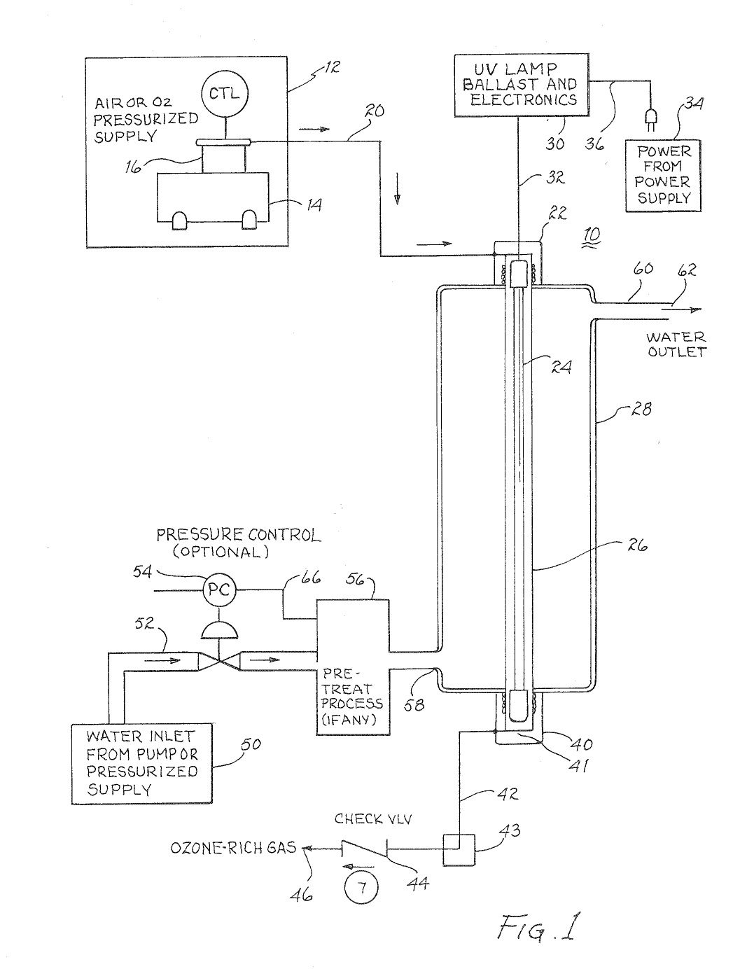

Referring to FIG. 1, there is illustrated a water purification apparatus 10. A source 12 may include a pump 14 for compressing air, oxygen or an oxygen containing gas to a pressure above ambient. Initial experiments indicate that a pressure of two or more atmospheres is preferable but more recent experiments suggest that a pressure of about five (5) atmospheres provides excellent results. The pressurized oxygen containing gas is conveyed through conduit 20 to a chamber or space within end cap 22. The flow of gas may be controlled by a unit 16 which may be a pressure flow controller or a compressor that pumps a fixed flow of gas against a fixed back pressure. An ultraviolet lamp, supported in part by end cap 22, is surrounded by an ultraviolet transmissive sleeve 26. The oxygen in the oxygen containing gas surrounding lamp 24 within sleeve 26 is partially converted to ozone. The degree of conversion is partially controlled by and a function of the pressure of the oxygen containing gas. The sleeve is disposed within tank 28 containing water flowing therethrough and about the sleeve. A ballast 30 and associated electronics provides electric power to lamp 24 via conductor 32. Power for the ballast is provided by a power supply 34 via a conductor 36 connectable to the power supply. A second end cap 40 supports the other end of lamp 24 and sleeve 26. It includes a chamber or space in fluid communication with conduit 42, which conduit draws the ozone enriched gas (or air) from within sleeve 26. To maintain the pressure within sleeve 26 at a well above ambient pressure and thereby enhance the formation of ozone (03), a pressure regulator 43 may be incorporated downstream of the outlet of the sleeve. A check valve 44 may be incorporated in conduit 42 to prevent backflow. As will be described in more detail below, outlet 46 of conduit 42 may be connected at any of several locations to inject the ozone enriched gas into the water to be treated.

A source 50 of water under pressure provides a flow of water into conduit 52. A pressure control 54 limits the pressure of the water flowing through conduit 52 into a pretreatment processor 56. Such a pretreatment processor may be a mechanical filter, other type of filter or any other water processor commonly used in the industry. Alternatively, the pretreatment processor may be omitted. Outlet 58, in fluid communication with conduit 52, passes the water under pressure into tank 28. Water within the tank swirls about sleeve 26 and flows out of the tank into conduit 60. Outlet 62 of conduit 60 is connected to a point of use of the water or to other equipment. As the water within tank 28 swirls about sleeve 26, it is irradiated with ultraviolet radiation emitted by ultraviolet lamp 24; necessarily, the sleeve must be transmissive to ultraviolet radiation. Materials for the sleeve includes quartz, and manmade materials sold under the trademark Teflon.

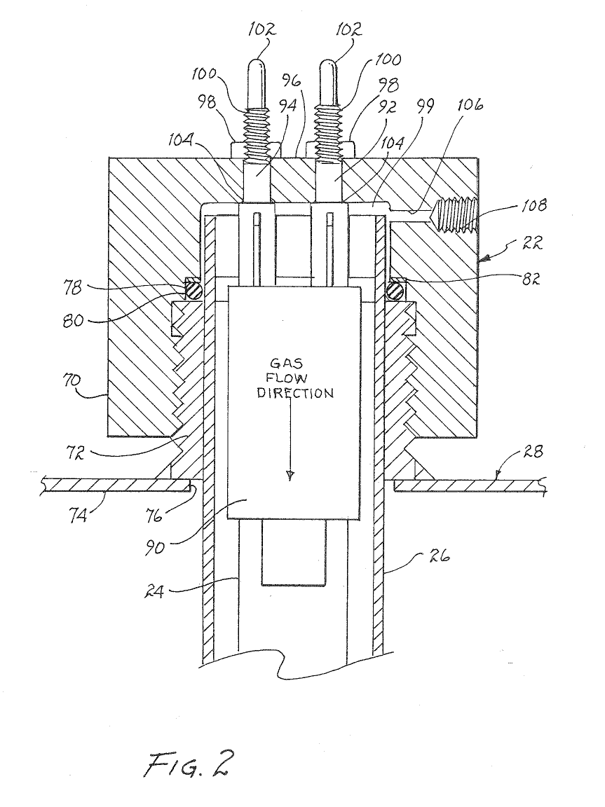

Referring to FIG. 2, end cap 22 will be described in greater detail. A cap 70 is in threaded engagement with a nipple 72 secured to a wall 74 of tank 28 about an aperture 76 disposed in the wall. To prevent deterioration of cap 70 from exposure to ultraviolet radiation and ozone, the cap is preferably made of a material such as a polycarbonate, CPVC, or materials sold under the trademark Kynar. An annular groove 78 in cap 70 supports an O-ring 80, which O-ring is preferably of silicone, EPDM or materials sold under the trademark Viton, which materials are ozone resistant. A seal washer 82 may be mounted upon the O-ring to establish a low friction environment between the washer and the O-ring to permit the washer to rotate with respect to the O-ring as cap 70 is brought into threaded engagement with the nipple. For purposes of long life, the seal washer should also be of similar ozone resistant material as the 0-ring. The seal washer may be omitted and replaced by a bead of silicon grease or even water, at the time the cap is brought into threaded engagement with the nipple. Upon engagement of the cap with the nipple, the O-ring is brought into sealed engagement with the top annular surface of the nipple, the perimeter of groove 78 and the cylindrical surface of sleeve 26 to establish three sealed surfaces. Thereby, water outflow through the annular space between the nipple and the sleeve is precluded and the gaseous atmosphere within the sleeve is sealed against outflow to the atmosphere.

The end cap construction described and illustrated in FIG. 2 has several advantages. The seal construction isolates all pressurized compartments from one another by a single O-ring. Most existing ultraviolet chambers for irradiation of water use nipples similar to that described above. This permits ready use of end caps 22, 40 (see FIG. 1) to convert such chambers into being able to embody and incorporate the present invention. The O-ring seal exerts only external circumferential stresses on the sleeve. Such stresses permit the use of brittle materials, such as quartz, for the sleeve without danger of collapse/breakage of the sleeve. The inflowing oxygen containing gas flows past the electrical connections in end cap 22 and effectively maintains the space free of ozone and the corrosive/oxidative effect of ozone upon such connections is eliminated.

Lamp 24 is a conventional commercially available ultraviolet lamp and it includes a base 90 having a pair of pins extending therefrom for connection to a source of electricity provided by a ballast. Socket assemblies 92, 94 are mounted in end 96 of cap 70 to receive and become electrically connected with the respective pins extending from base 90. Nuts 98 threadedly engage threaded sections 100 of each socket assembly to secure the socket assemblies in place. O-ring 104, mounted on a shoulder of each socket assembly, provides a seal to preclude any fluid communication between the ambient atmosphere and internal chamber or space 99 within cap 70. The configuration and spacing of pins 102 of the socket assemblies are commensurate in size and spacing with the pins extending from base 90 of lamp 24. Thereby, a conventional socket for electrically connecting the lamp may be used in conjunction with the socket assemblies. A passageway 106 is in fluid communication with the interior space 99 in end cap 22. The passageway is terminated by a threaded section 108 for threadedly receiving the end of a conduit. For example, conduit 20 (see FIG. 1), conveying the pressurized oxygen containing gas into end cap 22, may be threadedly engaged with threaded section 108 and in fluid communication with passageway 106.

End cap 40 (see FIG. 1) and its associated nipple are similar to end cap 22 except that it does not include any socket assemblies and directly related structures. Thus, the end of end cap 40 need not be and is not apertured for these reasons as is end cap 22 shown in FIG. 2. Conduit 42, extending from end cap 40 is in threaded engagement with a passageway 41 in end cap 40 to convey the outflow of ozone enriched gas (or air). Upon inspection, it will become apparent that initial installation and replacement of lamp 24 is possible upon removal of end cap 40 to insert the lamp into sleeve 26. After insertion, end cap 40 is threadedly mounted upon its nipple.

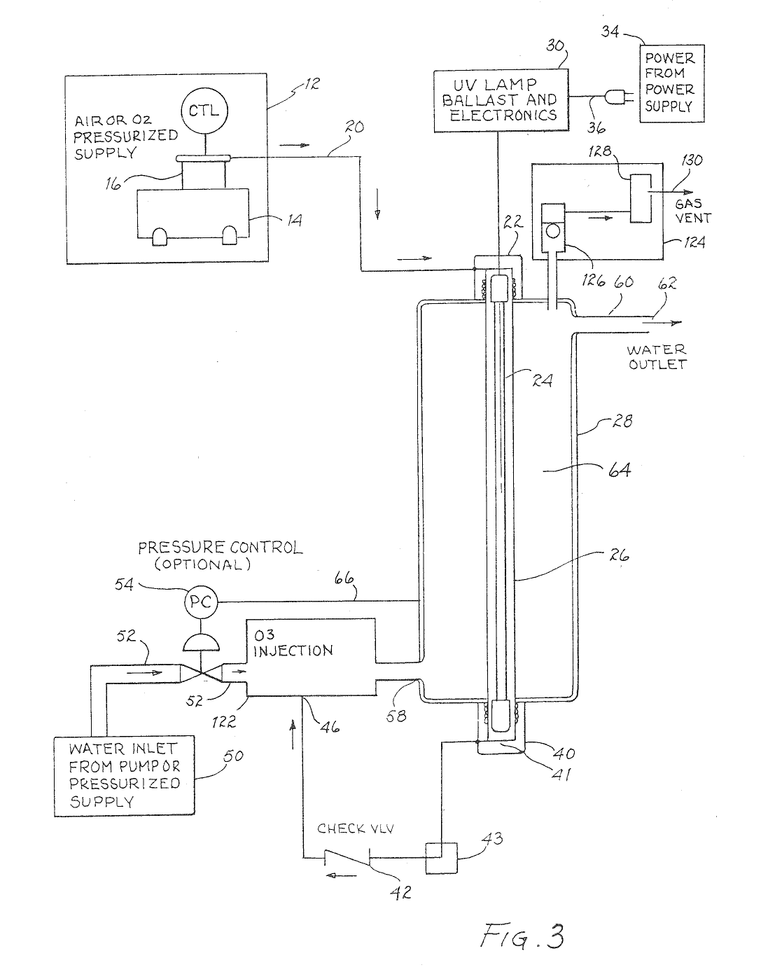

Referring to FIG. 3, there is illustrated a variant 120 of water purification apparatus 10 shown in FIG. 1. The differences therebetween will be reviewed. The ozone flowing through pressure regulator 43 and outlet 46 downstream of check valve 42 is introduced to an ozone injection unit 122 in fluid communication with water inflow through conduit 52 downstream of pressure control 54. The mode for entraining the ozone within the water flowing through conduit 52 may be by use of a sparger, venturi or other device known in the art for entraining a gas within a liquid. As a result of the injection of ozone into the inflowing water, water 64 present within tank 28 will have been ozonated; that is, water 64 will include entrained ozone. The ozone will be subjected to ultraviolet radiation emanating from lamp 24. Such irradiation will catalyze the ozone and increase the speed and efficiency of the oxidative reaction of the ozone upon any organic matter present within the water. In addition, the water will be irradiated with ultraviolet radiation from lamp 24, which radiation serves as a germicide to purify the water within tank 28.

If the ultimate use of the irradiated and ozonated water can or will tolerate the presence of ozone in the water flowing through conduit 60 and exiting through outlet 62, removal of the ozone is not necessary. However, if the presence of ozone is not acceptable to the end user or to the end use environment, the ozone percolating upwardly through water 64 to the top of tank 28 can be withdrawn through vent device 124. This device is conventional and may include an off-gas filter 126 and gas vent 128 which, in combination, convert the ozone into oxygen for discharge into the atmosphere through a discharge vent 130.

Based upon experiments conducted, the ultraviolet radiation of the ozone in the ozonated water increases the energy of the ozone and causes a more rapid oxidation reaction then would otherwise be possible. Moreover, the oxidation of chlorinated hydrocarbons is on the order of 10 to 10,000 times faster than ozone alone when it is not being irradiated by ultraviolet radiation. Oxidative reaction of alcohols, amino acids, fatty acids and polyalcohols can be increased 100 to 10,000 times faster.

As noted in FIG. 1, a feedback conduit 66 may be used to interconnect pretreatment processor 56 with pressure control 54 to ensure that the pressure of the water flowing into tank 28 through outlet 58 is within a predetermined pressure range. As shown in FIG. 3, feedback conduit 66 may provide a feedback pressure signal reflective of the pressure of water 64 in tank 28 to control/regulate operation of pressure control 54.

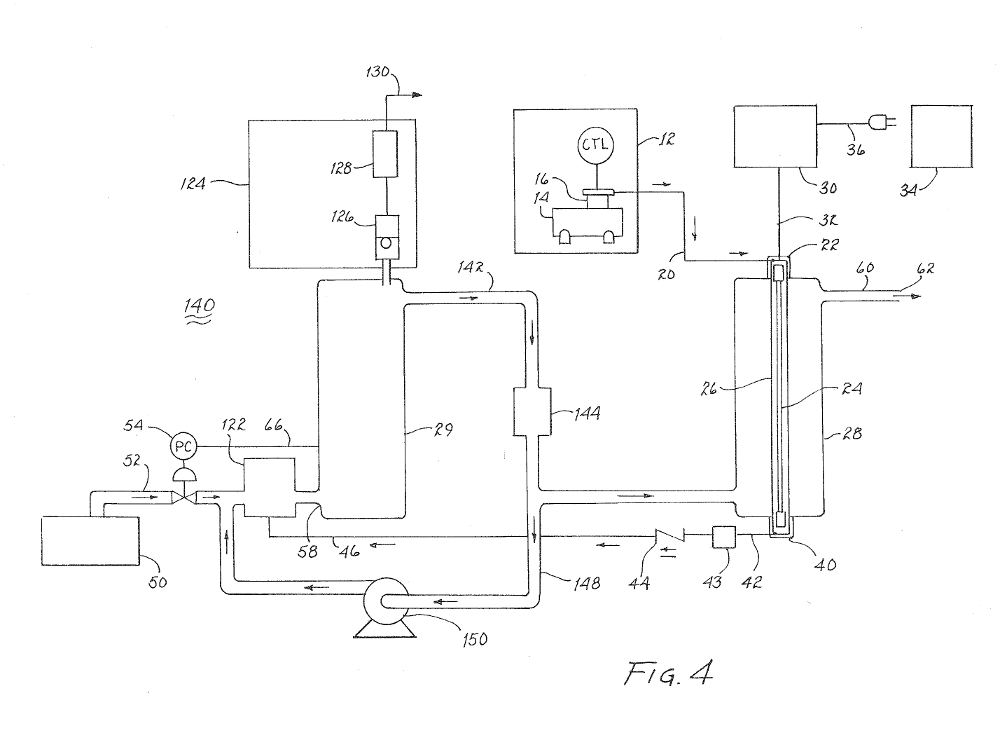

FIG. 4 illustrates a further variant 140 of water purification apparatus 10 shown in FIG. 1. This variant performs the same functions of water purification apparatus 120 shown in FIG. 3 except that the ozonation process and the ultraviolet irradiation process are performed in different tanks and the option of recirculating the irradiated water is possible. In view of these similarities, the following discussion will be focused primarily upon the additional structure and operation of variant 140 of the water purification apparatus.

Water from a source 50 of water under pressure is conveyed through conduit 52 via pressure control 54 into tank 29. An ozone injection unit 122 entrains ozone with the inflowing water. The ozonated water performs an oxidative reaction with organic matter present within the water in tank 29. Ozone collected at the top of the tank is withdrawn by vent device 124 and converted into oxygen for discharge into the atmosphere through vent 130. The ozonated water is discharged through a conduit 142. The ozonated water may be filtered through a filter 144 to remove particulate matter present. Conduit 142 splits into a conduit 146 for conveying the ozonated water to tank 28 and into recirculating conduit 148. Conduit 148 conveys the water from which the ozone has been removed into conduit 52 upstream of ozone injection unit 122. Thereby, the recirculating ozonated water is mixed with the water flowing from water supply 50 and the mixed flow of water is entrained with ozone by the ozone injection unit. To ensure ongoing flow of the recirculating ozonated water and to overcome pressure drops present, a pump 150 may be placed in fluid communication with recirculating conduit 148.

The ozonated water flowing through conduit 146 is discharged into tank 28. This tank includes an ultraviolet lamp 24 surrounded by an ultraviolet radiation transmissive sleeve 26. Upon energizing the lamp, the water flowing through tank 28 will be irradiated with ultraviolet light, as described above. As described above, the oxygen containing gas within sleeve 26 and surrounding lamp 24 is under pressure as a function of source 12 of oxygen and pressure regulator 43. The oxygen in the gas will be converted to ozone under pressure. The ozone will be discharged through end cap 40 into conduit 42, through check valve 44 and into ozone injection unit 122.

The ozonated water created in tank 29 is stripped of ozone by vent device 124. Thus, the water flowing through conduit 146 into tank 28 is water essentially devoid of any ozone content. The water irradiated within tank 28 with ultraviolet radiation is discharged to a point of use through outlet 62 of conduit 60. This water will have been purified by subjecting it to ozone and irradiating it with ultraviolet radiation. Moreover, particulate matter present in the water introduced from water source 50 or resulting from the oxidative reaction within tank 29 will have been essentially removed by filter 144. Thereby, the water discharged through outlet 62 is essentially devoid of particulate matter and ozone and has been purified.

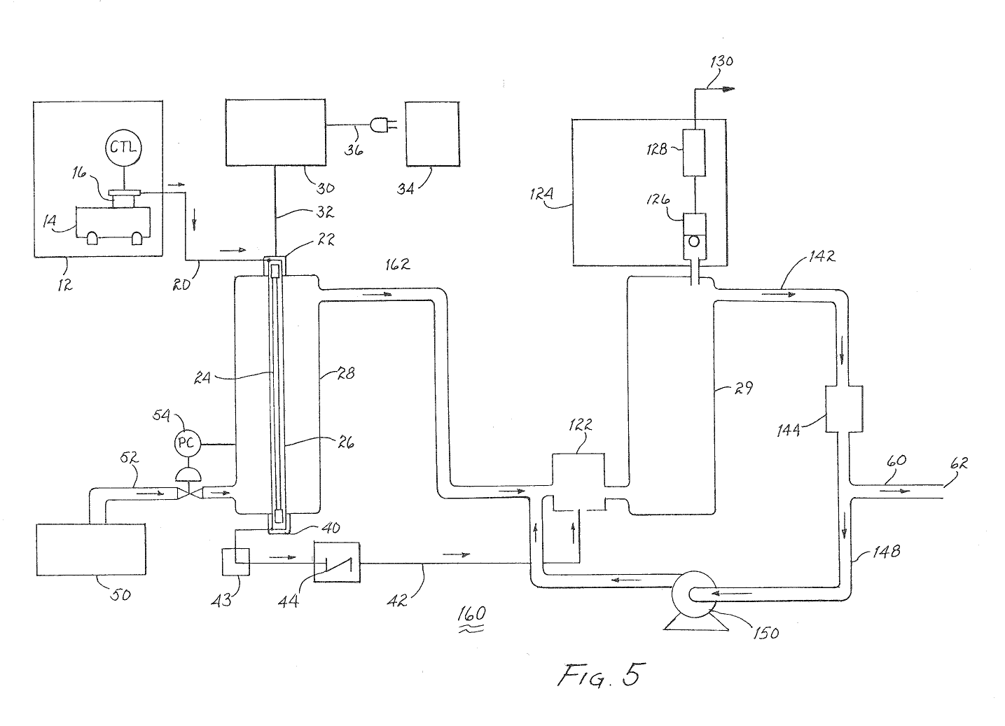

FIG. 5 illustrates a variant 160 of the water purification unit shown in FIG. 4 except that the order of ultraviolet irradiation and ozonation have been reversed. Water from source 50 under pressure is conveyed through conduit 52 into tank 28 via pressure control 54. A gas under pressure containing oxygen is conveyed from source 12 to end cap 22 and into the space intermediate sleeve 26 and ultraviolet lamp 24. Upon operation of the lamp, the water within tank 28 will be irradiated with ultraviolet radiation. Simultaneously, ozone will be produced and vented through end cap 40 into conduit 42. The pressure within sleeve 26 is maintained by pressure regulator 43. The irradiated water is transported via conduit 162 into tank 29 via ozone injection unit 122. The ozone injection unit receives ozone from conduit 42 and entrains the ozone into the water flowing therethrough. In tank 29, the ozone entrained in the water will have an oxidative reaction with any organic matter that may be present. The ozone within the tank percolating to the top of the tank is vented by vent device 124 to the atmosphere via vent 130 after the ozone has been converted to oxygen. The ozonated water is conveyed from tank 29 via conduit 142 into conduit 60 and exhausted through outlet 62 to a point of use. A filter 144 may be disposed in conduit 142 to remove any particulate matter that may have been introduced from source 50 of the water supply or as a result of ultraviolet radiation and ozonation of organic/inorganic matter present. The ozonated water may be recirculated through conduit 148 for injection into conduit 162 upstream of ozone injection unit 122. Thereby, a high level of ozone entrainment in the water present within tank 29 can be maintained during non-discharge of water through outlet 62. To augment the circulation, a pump 150 may be disposed in conduit 148.

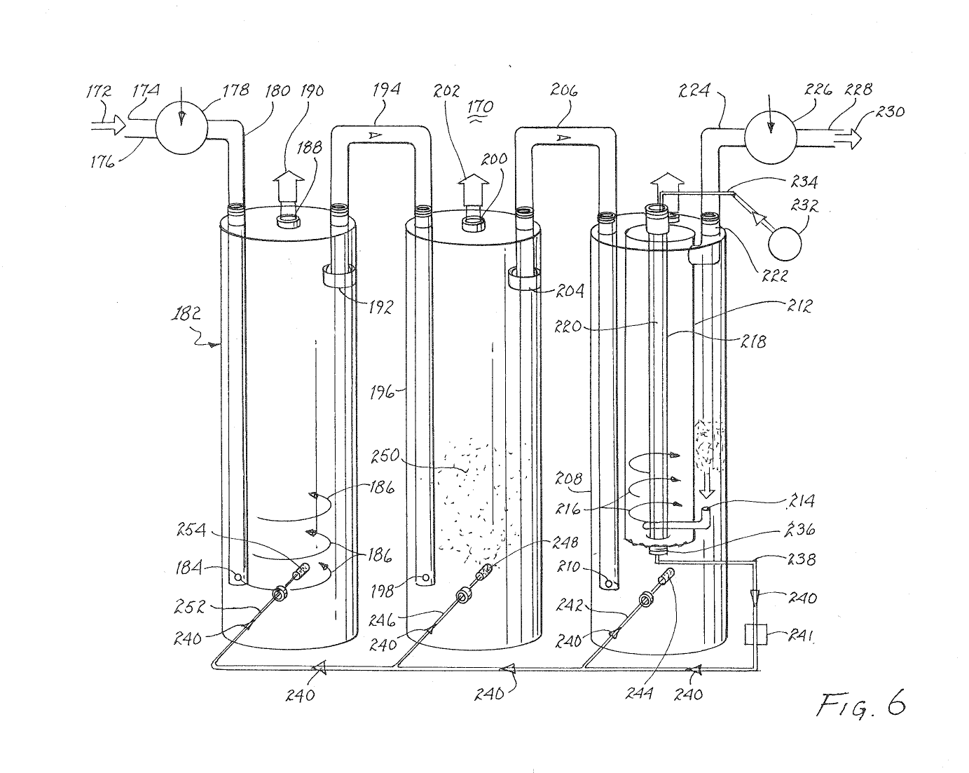

FIG. 6 illustrates a commercial embodiment 170 of the present invention. Water to be irradiated with ultraviolet light and ozonated is represented by arrow 172 entering inlet 174 of conduit 176. A pre filter 178 may be incorporated in conduit 176 for filtration purposes. Conduit 180 extending from filter 178 (if used) conveys the water into a tank 182. The water is ejected from conduit 180 through an outlet 184 configured and oriented to cause a swirling motion within tank 182, as represented by arrows 186. A vent 188 may be disposed at the top of tank 186 for out-gassing purposes, as represented by arrow 190. Water is discharged from tank 182 through an outlet 192 located at the upper end of the tank and into a conduit 194.

The water flowing through conduit 194 is discharged into tank 196 through an outlet 198 configured to cause a swirling motion of the water within the tank, which swirling motion is similar to that illustrated with respect to tank 182. Tank 196 also includes a vent 200 for discharging gas as represented by arrow 202. Water is discharged from tank 196 through an outlet 204 located at the upper end of the tank and into a conduit 206.

Tank 208 receives water from conduit 206, which water is discharged through outlet 210.

This outlet, like outlets 184 and 198, is preferably configured to cause a swirling motion of the discharged water within tank 208, as represented by arrows 186 in tank 182. A second tank 212 is mounted within tank 208. Water from within tank 208 flows into tank 212 through an inlet conduit 214. This inlet conduit is oriented to cause a swirling motion within tank 212 as represented by arrows 216. A sleeve 218 extends into tank 212 and houses an ultraviolet lamp 220. Outflow of water from within tank 212 occurs through an outlet 222 in fluid communication with a conduit 224. A filter 226 may be disposed in conduit 224 to capture particulate matter. A further conduit 228 conveys the water to a point of use, as represented by arrow 230.

A source 232 of compressed air is conveyed into sleeve 218 via a conduit 234. The air within the sleeve is compressed to a pressure in the range of about two (2) atmospheres to about five (5) atmospheres. The air within the sleeve flows about UV lamp 220 and is irradiated by the ultraviolet radiation from the U-V lamp to produce ozone. It is to be understood that the gas flowing into sleeve 218 may be air, oxygen or some gas containing oxygen. By maintaining the air under pressure by use of a pressure regulator 241, a higher concentration of ozone is produced than would be present than if the air were at or close to ambient pressure. An outlet 236 at the bottom of sleeve 218 is connected to a conduit 238 for conveying the ozone enriched air out of sleeve 218. The flow of ozone enriched air is represented by arrows 240 associated with conduit 238. A branch conduit 242 in fluid communication with conduit 238 is terminated by a sparger 244 for discharging the ozone enriched air into the water within tank 208. A further branch conduit 246 in fluid communication with conduit 238 conveys ozone enriched air to sparger 248 for discharging the ozone enriched air into tank 196. Such discharge is represented by bubbles 250. Although not shown within tanks 182, 208, bubbles 250 of ozone would be present therein also. A further branch conduit 252 in fluid communication with conduit 238 conveys ozone enriched air to sparger 254 for discharge into the water within tank 182.

From the above description, it is evident that the water inflowing into each of tanks 182, 196 and 208 is caused to swirl therewithin and generally flow in a turbulent manner within each respective tank. By use of spargers 244, 248 and 254, the water within each of tanks 208, 196 and 182, respectively, becomes entrained with ozone, which entrainment is enhanced by the swirling motion of the water. As discussed above, the ozone has an oxidative effective upon any organic material (bacteria, viruses, etc.) to destroy same. The water swirling within tank 208 about sleeve 218 is irradiated with ultraviolet light emanating from lamp 220. Such irradiation will have a germicidal effect upon any organic matter in the water. Accordingly, commercial embodiment 170 will purify the water flowing therethrough with the introduction of ozone to oxidate organic material that may be present and the water is irradiated with ultraviolet light that has a germicidal effect upon any living elements. As discussed above and depending upon the needs of the end use of the purified water, apparatus may be incorporated to remove ozone from the water prior to delivery to the end user.

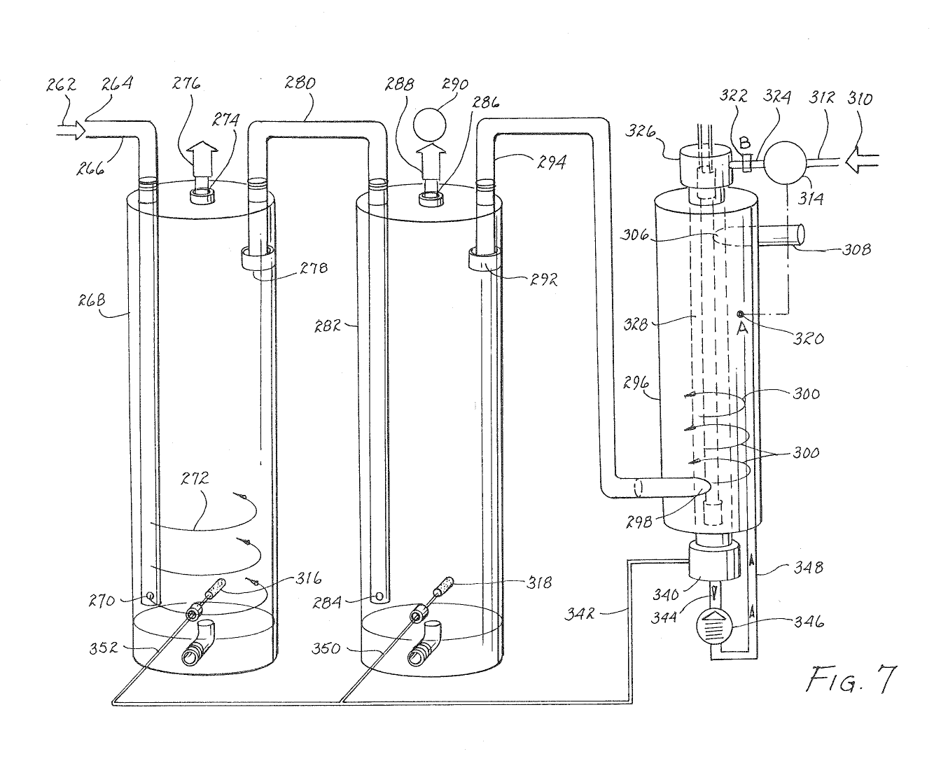

FIG. 7 illustrates a further commercial embodiment 260 of the present invention. Water to be irradiated with ultraviolet light and ozonated is represented by arrow 262 entering inlet 264 of conduit 266. A pre filter may be incorporated in conduit 176 for filtration purposes. Conduit 266 conveys the water into a tank 268. The water is ejected from conduit 266 through an outlet 270 configured and oriented to cause a swirling motion within tank 268, as represented by arrows 272. A vent 274 may be disposed at the top of the tank 268 for out-gassing purposes, as represented by arrow 276. Water is discharged from tank 268 through an outlet 278 located at the upper end of the tank and into a conduit 280.

The water flowing through conduit 280 is discharged into tank 282 through an outlet 284 configured to cause a swirling motion of the water within the tank, wichi swirling motion is similar to that illustrated with respect to tank 268. Tank 282 also includes a vent 286 for discharging gas as represented by arrow 288. An off-gas filter 290 may be sued in each of tanks 268 and 282 to remove ozone from the discharged gas (air). Water is discharged from tank 282 through an outlet 292 located at the upper end of the tank and into a conduit 294.

Tank 296 receives water from conduit 294, which water is discharged through outlet 298. This outlet, like outlets 270 and 284, is preferably configured to cause a swirling motion of the discharged water within tank 296, as represented by arrows 300 in the tank. A sleeve 302 extends into tank 296 and houses an ultraviolet lamp 304. Outflow of water from within tank 296 occurs through an outlet 306 in fluid communication with a conduit 308. A filter may be disposed in conduit 308 to capture particulate matter. A further conduit may convey the water to a point of use.

A source 310 of compressed air is conveyed through a conduit 312 to a differential pressure regulator 314. As will be described in further detail below, a sparger 316 is disposed within tank 268 for discharging ozone into the water in the tank. Similarly, a sparger 318 is disposed within tank 282 for discharging ozone into the water within the tank. The amount and rate of outflow of ozone from each of spargers 216, 318 is a function of the pressure differential between the ozone being discharged and the pressure of the surrounding water. For example, if a sparger is selected which discharges gas at a satisfactory flow rate when the pressure differential is 10 PSI, the pressure differential should be maintained at or about 10 PSI. This pressure differential is achieved by differential pressure regulator 314. The differential pressure regulator includes a pressure sensor 320, depicted by the letter A, disposed within tank 296 and a pressure sensor 322, depicted by letter B, in inlet line 324 that provides a flow of air into sleeve 302. By sensing these two pressures a differential pressure of about 10 PSI (or other pressure) can be maintained. This assumes that source 310 of compressed air is at a pressure sufficiently high to insure that the pressure within inlet line 324 can be at or about 10 PSI (or other pressure) above the pressure in the water within tank 296. Thereby, the pressure within the sleeve can be very high to enhance ozone production without compromising the structural integrity of the sleeve.

The air from inlet line 324 flows into cap 326 and is channeled into annular space 328 between sleeve 302 and UV lamp 304. The air within space 328 is irradiated by the U lamp to convert some of the oxygen molecules into ozone molecules. By experiments, it has been determined that the conversion of oxygen molecules into ozone molecules is significantly enhanced as a function of the pressure of the air or oxygen containing gas being irradiated.

Sleeve 302 is of limited strength and will burst if the pressure therewithin is above a predetermined pressure of the water surrounding the sleeve. It is therefore necessary to insure that this pressure differential does not approach the burst strength of the sleeve. The ozone enriched air within space 328 is channeled into a fitting 340. This fitting channels the ozone enriched air into conduit 342 and into conduit 344. A differential pressure regulator 346 is in line with conduit 344 to regulate the pressure of the ozone enriched air within space 328 to insure that the pressure differential between the pressure within space 328 and the pressure in the water within tank 296 does not exceed the burst strength of sleeve 302. This is accomplished by having the discharge side of differential pressure regulator 346 connected to tank 296 via conduit 348 to establish fluid communication between the water within the tank and the discharge side of the differential pressure regulator. Thereby, should the pressure of the water within tank 296 diminish a significant degree, the pressure differential between the pressure in space 328 and the pressure in the water within tank 296 will be maintained within the burst limits of sleeve 302 by relieving the pressure in space 328 through discharge of ozonated air through differential pressure regulator 346 into the tank.

Conduit 342, conveying ozonated air (gas) is coupled with a conduit 350 to provide ozonated air to sparger 318. Conduit 350 is also coupled with conduit 352 to provide ozonated air to sparger 316. The pressure of the ozonated air discharged from each of these spargers will be at an optimum flow rate by maintaining a preferred pressure differential between the ozonated air being discharged and the pressure in the water of the respective tank.

From the above description, it is evident that the discharge of ozonated air (gas) from each sparger is at an optimum flow rate as a function of the pressure differential between the gas being discharged and the water into which it is discharged. Irrespective of the pressure of the water within tank 296 (and also tanks 268, 282 as they are interconnected), the pressure within sleeve 302 is maintained by differential pressure regulator 314 to be at a predetermined pressure higher than the pressure within the tank. To protect against a sudden pressure drop of the water within tank 296, differential pressure regulator 246 will relieve the pressure within space 328 to an acceptable level by discharging ozonated air from within the space into tank 296 and prevent bursting of sleeve 302.

In summary, the present invention combines a high level of pressurized ozone production with simultaneous germicidal ultraviolet radiation to disinfect the water. Introducing the oxygen containing gas under pressure increases the efficiency of the ozone production; for example at an indicated pressure of about 65 psi within the sleeve about the lamp increases ozone production by an order of magnitude. The solubility of gases in water is directly proportioned to the pressure present (PV=NRT). Thus, the amount of ozone dissolved /entrained in the water is also significantly improved.

For safety reasons, a pressure valve in fluid communication with the interior of the sleeve is incorporated. To better control the rate of ozone production as a function of pressure, a differential pressure regulator, as described above, is used to control the pressure of the oxygen containing gas flowing into the sleeve. A further differential pressure regulator controls the pressure differential between the interior of the sleeve and the surrounding water. Other sensors and controls may be incorporated to regulate ultraviolet radiation intensity, gas flow rates, pressure, water flow rates and intermittent operation. For increased ozone production, oxygen may be added to or injected with the oxygen containing gas, or even used directly. To ensure efficient transmission of ultraviolet radiation through the sleeve, a wiper apparatus to wipe film, contamination, etc. from the surfaces of the sleeve may be incorporated. Depending upon the nature of the oxygen containing gas, it may be filtered prior to introduction into the end cap/sleeve. Similarly, pre and/or post filtration of the water may be performed.

1. A water purification apparatus, said apparatus comprising in combination:
a) a tank for receiving, containing and discharging water to be purified;
b) an ultraviolet lamp for irradiating the water in said tank and any ozone entrained in the water;
c) a ultraviolet transmissive sleeve disposed about at least part of said lamp and defining a space about said lamp;
d) a source of oxygen containing gas under a pressure of not less than about two atmosphere;
e) a pressure regulator for maintaining the gas within said sleeve at a predetermined pressure;
f) a chamber in fluid communication with said source of oxygen containing gas for introducing the oxygen containing gas into said sleeve and about said lamp to generate ozone in response to ultraviolet irradiation of the oxygen containing gas;
g) entrainment means for entraining the ozone in the water received by said tank; and
h) an outlet for discharging the irradiated and ozonated water.

2. The apparatus as set forth in claim 1, including compressor means for pressurizing the oxygen containing gas to a pressure of about 65 psi prior to introduction of the oxygen containing gas into said chamber.

3. The apparatus as set forth in claim 1 including pressure control means for regulating the pressure of the water received by said tank.

4. The apparatus as set forth in claim 1, including means for evacuating ozone from said tank.

5. The apparatus as set forth in claim 1 wherein said tank includes a nipple for receiving an end of said sleeve, a cap for engaging said nipple and defining in part said chamber, said cap including an inlet for receiving the oxygen containing gas and directing the oxygen containing gas into said chamber, and a socket assembly supported by said cap for electrically engaging pins of said lamp.

6. The apparatus as set forth in claim 5 including a seal for precluding flow of a fluid into and out of said tank intermediate said sleeve and said nipple.

7. The apparatus as set forth in claim 6 wherein said end cap and said nipple are of ozone resistant material.

8-10. (canceled)

11. A water purification apparatus, said apparatus comprising in combination:
a) a first tank for receiving water to be purified;
b) a second tank for receiving the water from said first tank and for discharging the water to an outlet;
c) a source of oxygen containing gas under a pressure of not less than about two atmospheres;
d) an ultraviolet lamp disposed in said first tank within a sleeve defining a space between said lamp and said sleeve for receiving the oxygen containing gas to generate ozone and to irradiate the water in said first tank;
e) pressure regulating means for maintaining the pressure within said sleeve at a predetermined pressure;
f) a conduit for conveying the irradiated water from said first tank to said second tank; and
g) ozone injection means for entraining the ozone generated within said sleeve in the water in said second tank to produce ozonated water in said second tank.

12. The apparatus as set forth in claim 11, including a recirculating conduit for conveying the ozonated water in said second tank into said conduit upstream of said ozone injection means.

13. The apparatus as set forth in claim 1 1 wherein the pressure of the oxygen containing gas is about 65 psi.

14. The apparatus as set forth in claim 11 wherein the pressure of the oxygen containing gas is in a range of about two (2) atmospheres to about five (5) atmospheres.

15. The apparatus as set forth in claim 11 wherein said pressure regulating means comprises a differential pressure regulator for sensing the pressure of said source of oxygen containing gas and the pressure in said first tank.

16. The apparatus as set forth in claim 11, wherein said pressure regulating means comprises a differential pressure regulator for sensing the pressure within said sleeve and the pressure within said first tank and for discharging the oxygen containing gas into said first tank when the differential pressure exceeds a predetermined value.

17. The apparatus as set forth in claim 11 wherein said pressure regulating means comprises a differential pressure regulator for sensing the pressure of said source of oxygen containing gas and the pressure in said first tank.

18. A water purification apparatus, said water purification apparatus comprising in combination:
a) a first tank for receiving water to be purified;
b) a second tank for receiving the water from said first tank and for discharging the water to an outlet;
c) a source of oxygen containing gas under a pressure of not less than about two atmospheres;
d) an ultraviolet lamp disposed in said second tank within a sleeve defining a space between said sleeve and said lamp for receiving the oxygen containing gas to generate ozone and to irradiate the water in said second tank;
e) pressure regulating means for maintaining the pressure within said sleeve at a predetermined pressure;
f) a conduit for conveying the ozone from said second tank to said first tank; and
g) ozone injection means for entraining the ozone generated within said sleeve in the water in said first tank to produce ozonated water in said second tank.

19. The apparatus as set forth in claim 18 including a recirculating conduit for conveying the ozonated water in said second tank into said conduit upstream of said ozone injection means.

20. The apparatus as set forth in claim 18 wherein the pressure of the oxygen containing gas is about 65 psi.

21. The apparatus as set forth in claim 18 wherein the pressure of the oxygen containing gas is in the range of about two (2) atmospheres to about five (5) atmospheres.

22. The apparatus as set forth in claim 18 wherein said pressure regulating means comprises a differential pressure regulator for sensing the pressure of said source of oxygen containing gas and the pressure in said second tank.

23. The apparatus as set forth in claim 18, wherein said pressure regulating means comprises a differential pressure regulator for sensing the pressure within said sleeve and the pressure within said second tank and for discharging the oxygen containing gas into said second tank when the differential pressure exceeds a predetermined value.

24. The apparatus as set forth in claim 18 wherein said pressure regulating means comprises a differential pressure regulator for sensing the pressure of said source of oxygen containing gas and the pressure in said second tank.

25. A water purification apparatus, said apparatus comprising in combination:
a) a first tank for receiving water to be purified;
b) a second tank for receiving water from said first tank;
c) a source of oxygen containing gas at a pressure of not less than two (2) atmospheres;
d) an ultraviolet lamp disposed in said second tank within a sleeve defining a space between said lamp and said sleeve for receiving the oxygen containing gas to generate ozone and for irradiating the water within said second tank;
e) conduit means for conveying the ozone enriched oxygen containing gas into at least said first tank; and
f) a pressure regulator for maintaining the pressure within said sleeve.

26. The water purification apparatus as set forth in claim 25, including a sparger disposed in each of said first and second tanks for entraining the ozone enriched oxygen containing gas in the water in said first and second tanks.

27. The water purification apparatus as set forth in claim 26, including a water inlet in said first tank to urge a swirling motion of the inflowing water.

28. The water purification apparatus as set forth in claim 26, including a water inlet in said second tank to urge a swirling motion of the inflowing water.

29. The water purification apparatus as set forth in claim 28, including a water inlet in said first tank to urge a swirling motion of the inflowing water.

30. The water purification apparatus as set forth in claim 25, including a third tank for receiving water to be purified and a further conduit means for discharging water from said third tank to said first tank and yet further conduit means for conveying the ozone enriched oxygen containing gas into the water in said third tank.

31. The water purification apparatus as set forth in claim 30, including a water inlet in said third tank to urge a swirling motion of the inflowing water.

32. The water purification apparatus as set forth in claim 30, including a sparger disposed in said third tank for entraining the ozone enriched oxygen containing gas in the water in said third tank.

33. The water purification apparatus as set forth in claim 25, including a further tank disposed in said second tank for housing said sleeve and said lamp, for receiving water from said second tank and for discharging the ozonated and irradiated water to a point of use.

34. The water purification apparatus as set forth in claim 33, including an inlet conduit in fluid communication with said second tank and said further tank for introducing water to said further tank.

35. The water purification apparatus as set forth in claim 34, wherein said inlet conduit urges a swirling motion of the water flowing into said further tank.

36. The water purification apparatus as set forth in claim 25, wherein said sleeve is transmissive to ultraviolet radiation from said lamp and transmits ultraviolet radiation into the water within said further tank.

37. The apparatus as set forth in claim 25 wherein said pressure regulator comprises a differential pressure regulator for sensing the pressure of said source of oxygen containing gas and the pressure in said second tank.

38. The apparatus as set forth in claim 25, wherein said pressure regulator comprises a differential pressure regulator for sensing the pressure within said sleeve and the pressure within said second tank and for discharging the oxygen containing gas into said second tank when the differential pressure exceeds a predetermined value.

39. (canceled)
